(19) United States
(12) Patent Application Publication
(10) Pub. No.: US 2018/0293358 A1
(43) Pub. Date: Oct. 11, 2018

(54) PRESCRIPTION DRUG CUSTOMER MESSAGING SYSTEMS AND METHODS

(71) Applicant: Digital Health Dialog, LLC d/b/a EngagedMedia, South Lake, TX (US)

(72) Inventors: Hossain Sooudi, Atlanta, GA (US); Kenneth Burkett, South Lake, TX (US); Adam Beacham, South Lake, TX (US); Joe Jackson, Canton, GA (US); John Foss, South Lake, TX (US); Benjamin Hoefs, South Lake, TX (US); Or Maoz, Dunwoody, GA (US)

(73) Assignee: Digital Health Dialog, LLC d/b/a EngagedMedia, South Lake, TX (US)

(21) Appl. No.: 15/483,481

(22) Filed: Apr. 10, 2017

(51) Int. Cl. G06F 19/00; G06Q 10/10; G06Q 50/22; G06Q 30/02

(52) U.S. Cl. CPC G06F 19/3456; G06Q 10/109; G06Q 50/24; G06F 19/3406; G06Q 30/0267; G06Q 50/22

(57) ABSTRACT

A method includes receiving by a server computer a prescription drug claim transaction data from a claims processor over a data communications network, analyzing the prescription drug claim transaction data, and messaging a user device of a prescription drug customer in respect of the prescription drug claim transaction data.

### TECHNICAL FIELD

The present disclosure relates generally to communication networks and devices, and more particularly relates to wireless and networked communication devices for delivery of messaging based on pharmaceutical claims data.

### BACKGROUND

Conventionally, a medical patient obtains a written script for a prescription drug from a physician to address the patient's malady. The patient carries the written script to a pharmacy. The pharmacy enters the prescription drug transaction data for delivery to a claims processor. The claims processor receiving the transaction data adjudicates the prescription drug claim based on the transaction data. The adjudication may be successful, either for coverage through private insurance, government insurance or other program, or the result may be an uncovered claim. The patient makes payment according to any coverage and picks-up the prescription drug at the pharmacy.

As a result of the prescription drug transaction, prescription drug claim transaction data is available from the claims processor, as well as from intermediaries, such as any switch or other intermediary, communicating the transaction data. This prescription drug claim transaction data provides insight into the prescription drug adjudication and delivery process. By gaining such insight, a wide variety of services may be deliverable to the prescription drug customer.

Prescription drug customers may have access to a wide variety of communications devices. For example, cellular telephones and other wireless devices are a prevalent mode of communication for many consumers. These consumers include prescription drug patients and patient caregivers. These devices may often have communications capabilities, such as email, short message service (SMS), multimedia message service (MMS), enhanced message service (EMS), wireless access protocol service (WAP), and/or other messaging features for sending and receiving text and multimedia communications.

It would, therefore, be desirable to provide new and improved systems and methods for messaging prescription drug customers via user devices of the customers. It would also be desirable to assist the prescription drug claim adjudication and drug delivery process through targeted messaging to user devices of the customer or other consumer.

### SUMMARY

An embodiment of the invention is a system for messaging in a data communications network communicatively connected to a claims processor and a user device. The system includes a processor, a network interface communicatively connected to the processor and the data communications network, a memory communicatively connected to the processor. The memory includes instructions for causing the processor to receive over the data communications network from the claims processor a set of prescription drug claims data associated with the user device, analyze the prescription drug claims data, and message the user device over the data communications network.

Another embodiment of the invention is a method including receiving by a server computer a prescription drug claim transaction data from a claims processor over a data communications network, analyzing the prescription drug claim transaction data, and messaging a user device of a prescription drug customer in respect of the prescription drug claim transaction data.

### BRIEF DESCRIPTION OF THE DRAWINGS

The present invention is illustrated by way of example and not limitation in the accompanying figures, in which like references indicate similar elements, and in which:

FIG. 1 illustrates a system for messaging a prescription drug customer by a program processor to facilitate the prescription drug claim and delivery process, according to certain embodiments of the invention;

FIG. 2 illustrates a method of messaging for delivery of a one-click refill of a prescription drug for a user device of a prescription drug customer, according to certain embodiments of the invention;

FIG. 3 illustrates a method of messaging for delivery of a refill at the end of a prescription for a prescription drug, according to certain embodiments of the invention;

FIG. 4 illustrates a method of messaging for obtaining written authorization to pursue an appeal of a prescription drug claim adjudication, according to certain embodiments of the invention;

FIG. 5 illustrates a method of messaging for mail order delivery of a prescription drug, according to certain embodiments of the invention;

FIG. 6 illustrates a method of messaging for delivery of an award in connection with purchase of a prescription drug, according to certain embodiments of the invention;

FIG. 7 illustrates a method of messaging upon occurrence of a paid prescription drug claim that is reversed, according to certain embodiments of the invention;

FIG. 8 illustrates a method of delivering a survey to a prescription drug customer, according to certain embodiments of the invention;

FIG. 9 illustrates a method of enrollment of a prescription drug customer operating a user device for messaging, in a program operated by a program processor, according to certain embodiments of the invention; and

FIG. 10 illustrates a method of analyzing by a rules engine a prescription drug claims data, according to certain embodiments of the invention.

### DETAILED DESCRIPTION

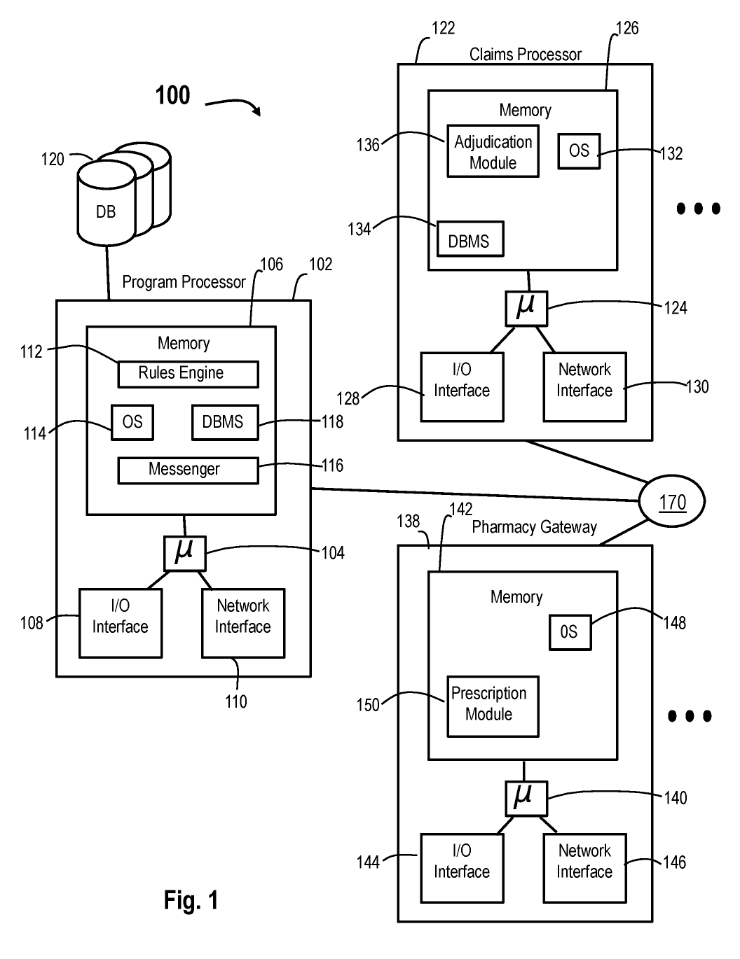

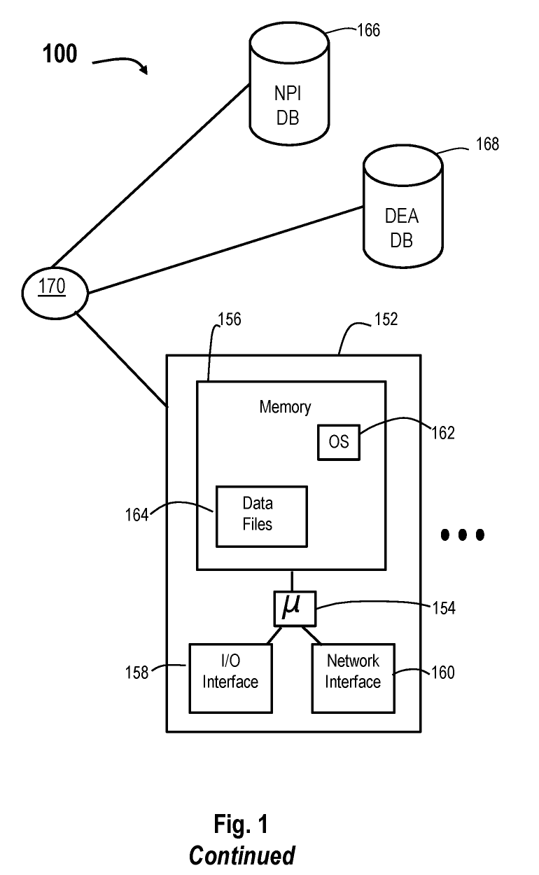

Referring to FIG. 1, a system 100 for messaging a prescription drug customer includes a program processor 102. The program processor 102 may comprise any processor driven device, such as a server computer or other computing device. The program processor 102 is configured for receiving and analyzing prescription drug claims data and messaging user devices of prescription drug customers corresponding to the claims data. The program processor 102 may include a processor 104, memory 106, input/output (I/O) interface(s) 108 and a network interface 110. The program processor 102 may also include, or communicatively connect to, a rules engine 112, operating system 114, messenger 116, database manager 118, and one or more database 120. The program processor 120 receives prescription drug claims data, the rules engine 112 analyzes that claims data according to programmed rules, and the messenger 116 sends applicable message(s) to a user device of a prescription drug customer associated with the claims data and enrolled in a program operated by the program processor 102.

The program processor 102 may also include, or communicatively connect to, one or more database 120. The one or more database 120 may include, for non-exclusive example, a redemption database, an eligibility database, an awards database, and/or other or further database(s). The program processor 102, in conjunction with the one or more database 120, determines eligibility of a prescription drug customer via a processing device of the customer for participation in a program of the program processor 102, such as an awards or discount program, a health management program, or other program.

An example embodiment of the program processor 102 is computer or processing device(s) operated by a party, such as, for example, an awards or discount program, health management program, or other entity, offering adjunct services to a prescription drug customer via a processing device of or associated with the prescription drug customer. Enrollees for the adjunct services are delivered targeted messages by the program processor 102 related to events or occurrences in the prescription drug adjudication and delivery process.

One or more claims processor 122 may also be included in the system 100. Each claims processor 122 may comprise any processor-driven device that is configured to receive, process, and fulfill requests relating to prescription drug claim adjudication processing. The claims processor 122 may include a processor 124, memory 126, I/O interface(s) 128, and network interface 130. The claims processor 122 may also include, or communicatively connect to, an operating system 132, a database manager 134, and an adjudication module 136. The adjudication module 136 produces or receives the claims data of a prescription drug claim based on input received from pharmacy gateway(s) on purchase of prescription drugs by prescription drug customers who operate user processing devices and are enrolled in the program(s) of the program processor 120.

An example embodiment of the claims processor 122 is computer or processing device(s) operated by a health insurance provider, pharmacy benefits provider, government program, third party payer system, drug manufacturers, other vendors and/or business associates of healthcare service providers, government and/or non-government entities providing financial and/or administrative services, or other vehicle for adjudication of prescription drug claims. The claims processor 122 may be any node or point of receipt and/or transmission of claims data in the prescription drug claim adjudication and prescription drug delivery process.

One or more pharmacy gateway 138 may also be included in the system 100. The pharmacy gateway 138 may comprise any processor driven device, such as a personal computer, laptop computer, handheld computer, point-of-sale system, or the like. The pharmacy gateway 138 is configured for receiving, processing and fulfilling prescription transactions from patients or health care providers. The pharmacy gateway 138 communicates with prescription drug transaction and adjudication entities. The pharmacy gateway 138 may include a processor 140, memory 142, I/O interface(s) 144, and network interface 146. The pharmacy gateway 138 may also include, or communicatively connect to, an operating system 148 and a prescription module 150. The prescription module 150 may receive, process and respond to prescriptions received, and generate claims transactions relating to filled (or to be filled) prescriptions to be routed to the one or more of the claims processor 122.

An example embodiment of the pharmacy gateway 138 is a point-of-sale device operated by a pharmacy or pharmaceutical retail vendor. Once the pharmacy or vendor receives a prescription from the patient or a healthcare provider, the pharmacy gateway 138 creates a claim to be adjudicated by the claims processor 122. The prescription claim may be in accordance with a version of a National Council for Prescription Drug Programs (NCPDP) Telecommunication standard, which may include, for example:

Prescriber Information
i. Name of the prescriber
ii. Prescriber identifier for a physician or healthcare provider Pharmacy Information
iii. Identifier of the pharmacy submitting the claim request

Patient Information
iv. Insurance or coverage information
v. Name, address, date of birth
vi. Patient diagnosis/condition

Prescription Information
vii. Identification of the prescribed drug or product (e.g., National Drug Code (NDC))
viii. Prescription number
ix. Quantity and/or days supply of the prescribed drug or product
x. Pricing information for the prescribed drug or product
xi. Date prescription written

Claims Processor Identifier
xii. Banking Identification Number (BIN)
xiii. Processor Control Number (PCN)
xiv. Other information
   Although certain example information is listed as comprising the prescription claim data that is entered by the pharmacy gateway 138, other or additional information may be included in the claim data. The prescription claim data is transmitted by the pharmacy gateway 138 for delivery to an applicable claims processor 122.

One or more user device 152 may also be included in the system 100. Each user device 152 may be a processor driven device, such as, for example, a cell phone, a desktop computer, a notebook computer, a tablet computer, digital assistant, or other processing device. Each user device 152 may include a processor 154, memory 156, I/O interface(s) 158, and network interface 160. The user device 152 may also include, or communicatively connect to, an operating system 162 and data files 164. The user device 152 can enroll in a program of the program processor 102 via messages received and sent by the user device 152 to the program processor 102. The user device 152 can also receive and transmit various messages of the program of the program processor 102. The messages received and transmitted by the user device 152 assist the user of the user device in the prescription drug claim adjudication and prescription drug delivery process, as well as in any discount or award program, health management program, or other program of the program processor 102.

In alternatives, the system 100 may also in certain embodiments include various sources of information, such as one or more database communicatively accessible over a network through a server computer or the like. For example, a national provider identifier (NPI) database 166 and/or a drug enforcement administration (DEA) database 168 may be accessed by the program processor 102 for relevant information ancillary and corresponding to particular claims data. Of course, different or additional sources of information, such as databases accessible through server computers of communicatively connected network(s), are possible.

The program processor 102, claims processor 122, pharmacy gateway 138, and user device 152 may be communicatively connected by one or more network 170. The one or more network 170 may be or include any telecommunication and/or data network, public, private, or a combination, including, for example, a packet-switched network (IP network), a public switched telephone network (PSTN), a cellular network, a local area network, a wide area network, an intranet, the Internet, intermediate hand-held data transfer devices, and/or any combination of these or other networks, and may be wired, wireless or combination.

In operation, a prescription drug customer associated with a user device 152 transacts for a prescription drug at a pharmacy gateway 138. The pharmacy gateway 138 enters a set of claims data associated with the prescription drug transaction. The pharmacy gateway 138 communicates the entered set of claims data to the claims processor 122. The communication can be direct, or indirect through one or more intermediary, such as a switch or other entity. The claims processor 122, although illustrated as a stand-alone unit, may be or include any node, module or equipment of the system 100 which receives claims data, either directly or through intermediaries.

The claims processor 122 adjudicates the prescription drug transaction based on the claims data from the pharmacy gateway 138. The adjudication may be that the claim is covered or not covered. Coverage may be by private insurer, government insurer or program, or otherwise. The claims data is received by the program processor 102, for example, from the claims processor 122. The claims data may be received by the program processor 102 via an application programming interface (API) of the claims processor 122 for such purpose, via a secure file transfer protocol (SFTP) server for such purpose, or other interface. The rules engine 112 of the program processor 102 analyzes the claims data. Based on the analysis, and information of the one or more database 120 and any other sources of information 166, 168, the program processor 102 messages the user device 152 over the network with a relevant message.

Messaging by the program processor 102 may be, for example, short message service (SMS), multimedia message service (MMS), enhanced message service (EMS), wireless access protocol service (WAP), email, hyptertext transfer protocol (HTTP), app or program message, or any other message over the network 170. The user device 152 receiving the message may respond or take other action (or not) in response to the message. For example, in certain embodiments, a select response message by the user device 152 to the program processor 102 triggers particular activity in the prescription drug claims adjudication and delivery process, in a rewards program, or in other respects.

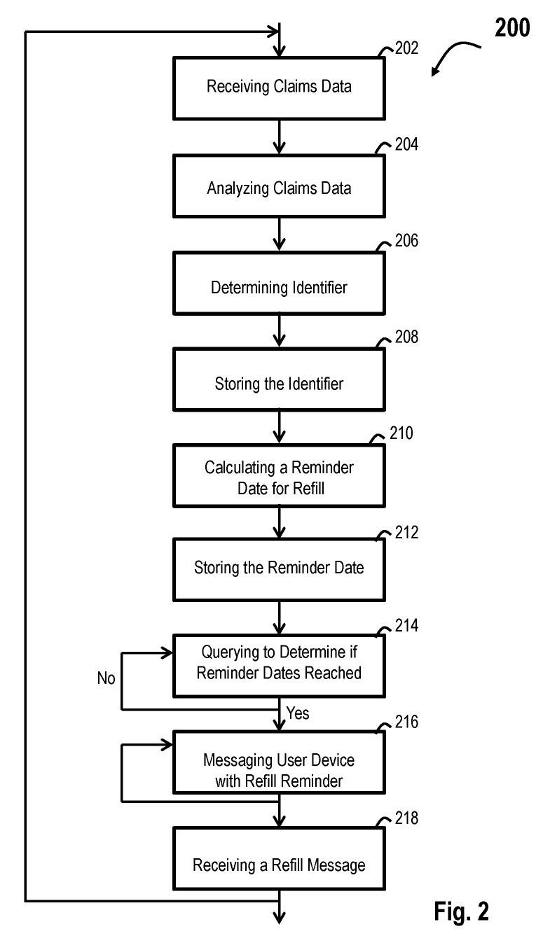

Referring to FIG. 2, a method 200 commences with receiving claims data 202 by a program processor from a claims processor. The claims data is analyzed 204 by the rules engine of the program processor. From the analyzing 204, the program processor determines an identifier 206 of a refill date for the prescription drug of the claim. The identifier is stored 208. The program processor calculates a reminder date 210 for the refill.

The program processor stores 212 the reminder date. The program processor then queries 214, intermittently or continuously as per the embodiment, to determine if the reminder date is reached. If the reminder date is not reached, the program processor continues querying 214. If the reminder date is reached, the program processor messages 216 a user device of the relevant prescription drug customer with a refill reminder. The step 216 of messaging may be performed more than once, such as daily or semi-daily as the refill date nears.

If a refill message is received 218 from the user device by the program processor, the program processor may communicate the refill message to a pharmacy gateway, the claims processor, or otherwise act.

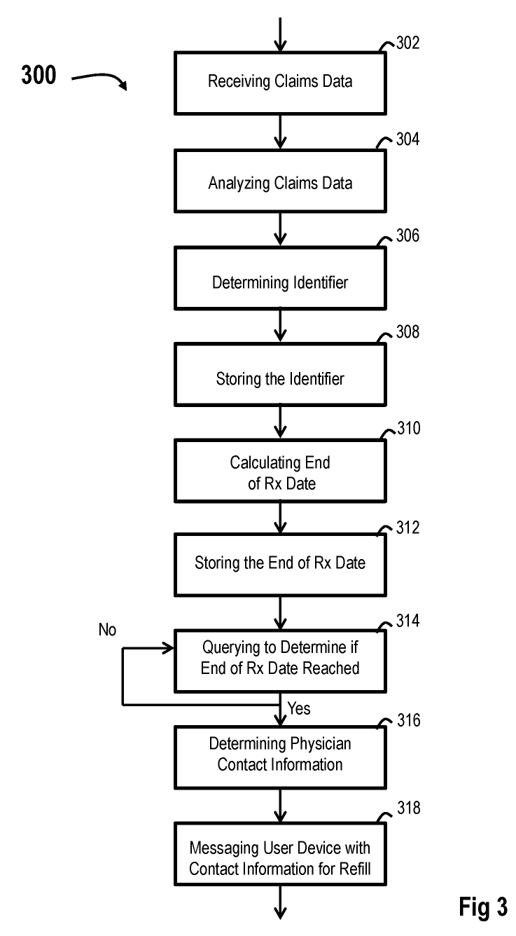

Referring to FIG. 3, a method 300 commences with receiving claims data by a program processor from a claims processor. The claims data so received is analyzed 304 by a rules engine of the program processor. The program processor determines an identifier 306 of an end of prescription date for the relevant claim and prescription drug. The program processor stores 308 the identifier. The program processor calculates 310 an end of prescription date, and stores the end of prescription date 312.

The program processor then queries 314, intermittently or continuously as desired in the embodiment, to determine if the end of prescription date is reached. If the end of prescription date is not reached, the program processor continues querying 314. If the end of prescription date is reached, the program processor determines 316 a physician contact information relevant to the prescription of the claim. The program processor may determine 316 the physician contact information via communications over a network with a source of the information, such as, for example, an NPI or DEA database. On obtaining the physician contact information, the program processor messages 318 the user device of the prescription drug claim with contact information of the physician for refill of the prescription.

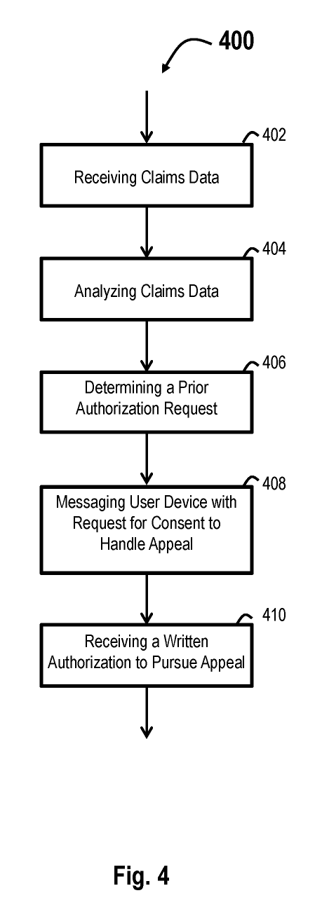

Referring to FIG. 4, a method 400 commences with receiving 402 claims data by a program processor from a claims processor. The method 400 continues with analyzing 404 the claims data by a rules engine of the program processor. The program processor determines 406 from the claims data that a prior authorization requirement applies to the prescription drug transaction. The program processor messages 408 a user device associated with the prescription drug transaction with a request for consent to handle appeal of the prescription drug transaction. In a step 410, the program processor receives a written authorization from the user device to pursue the appeal.

The method 400 may continue by automatedly, or through other or human interaction, filing an appeal with the claims processor regarding the prescription drug transaction.

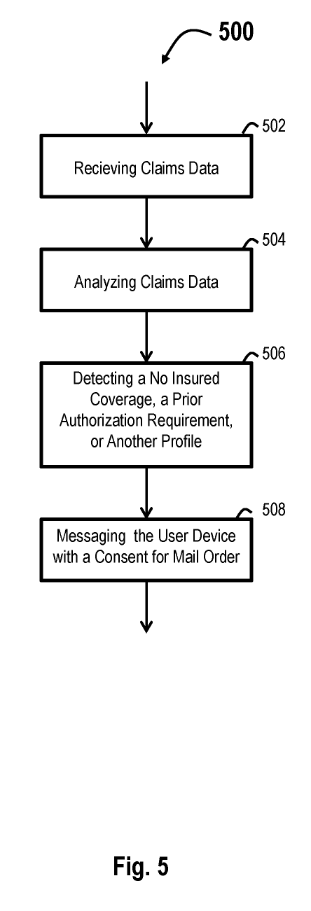

Referring to FIG. 5, a method 500 commences with receiving 502 claims data of a prescription drug transaction by a program processor from a claims processor. A rules engine of the program processor analyzes 504 the claims data. The program processor determines 506 that the prescription drug transaction presents either a no insured coverage, a prior authorization requirement, or another profile of the claims data. The program processor messages 508 the user device associated with the prescription drug transaction with a consent for mail order of the prescription drug.

The method 500 may continue by automatedly, or through other or human interaction, ordering the prescription drug for mail delivery.

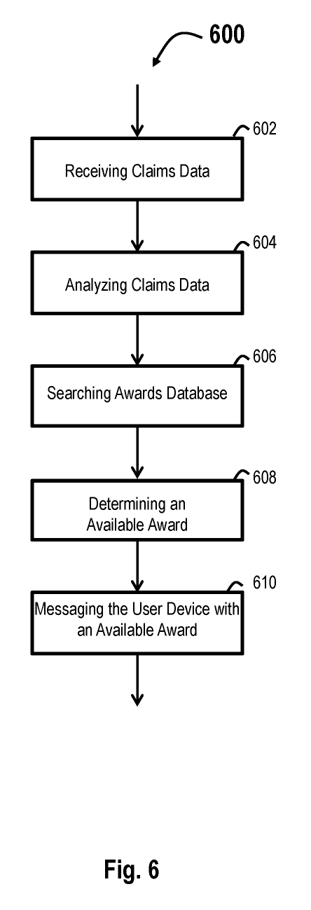

Referring to FIG. 6, a method 600 commences with receiving 602 claims data of a prescription drug transaction by a program processor from a claims processor. A rules engine of the program processor analyzes 604 the claims data. The program processor then searches an awards database to determine if a discount or other award applies for the prescription drug transaction. The program processor determines 608 an applicable award available for the user of the user device associated with the prescription drug transaction. The program processor messages 610 the user device with the available award.

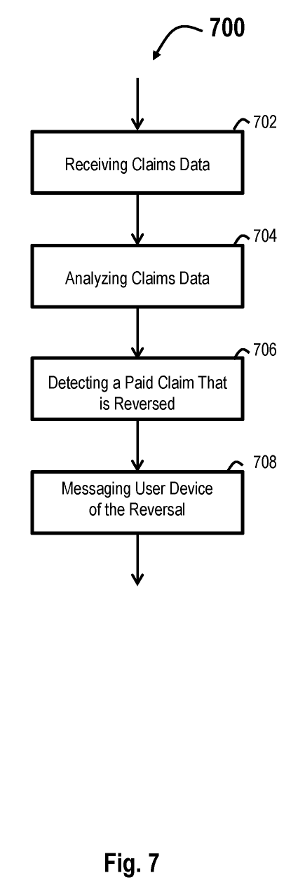

Referring to FIG. 7, a method 700 commences with receiving 702 claims data of a prescription drug transaction by a program processor from a claims processor. A rules engine of the program processor analyzes 704 the claims data. The program processor determines 706 that a paid claim is reversed in the prescription drug transaction. The program processor messages 708 a user device of a prescription drug customer associated with the prescription drug transaction that the paid claim is reversed.

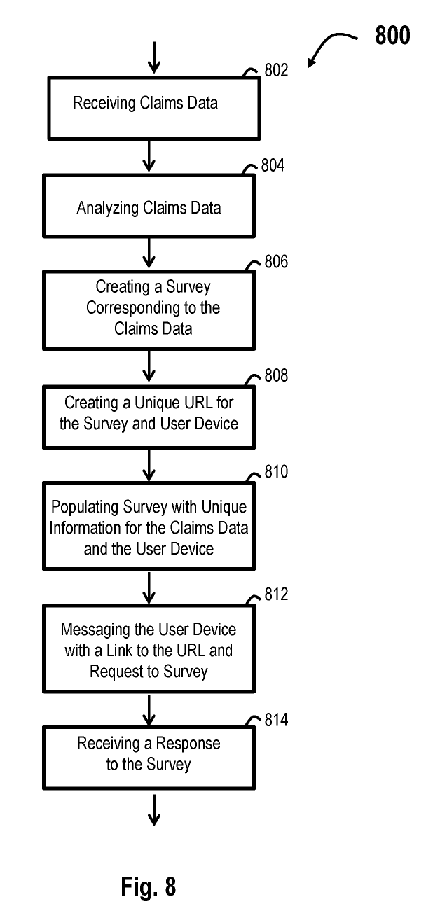

Referring to FIG. 8, a method 800 commences with receiving 802 claims data of a prescription drug transaction by a program processor from a claims processor. A rules engine of the program processor analyzes 804 the claims data. Responsive to analyzing 804, the program processor creates 806 a survey corresponding to the claims data. The program processor creates 808 a unique Uniform Resources Locator (URL) for the survey and the user device of the prescription drug customer of the prescription drug claim. The program processor populates 810 the survey with unique information for the claims data and the user device. The program processor messages 812 the user device with a link to the URL and a request to take the survey. The program processor receives 814 from the user device a response to the survey.

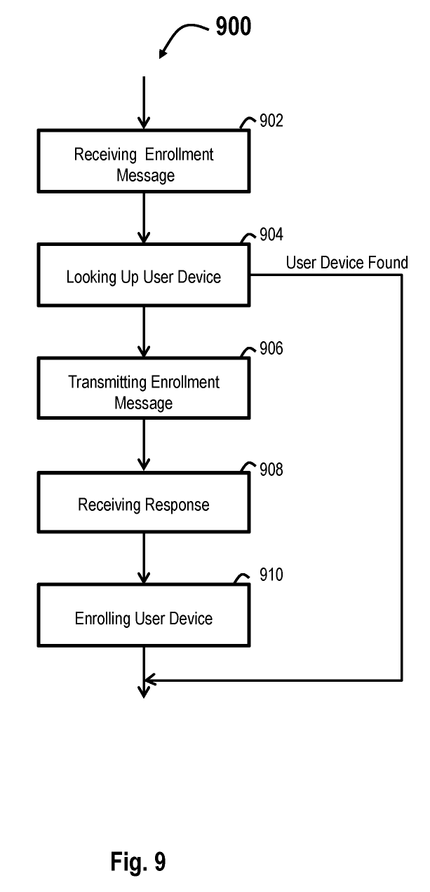

Referring to FIG. 9, a method 900 of enrollment in a program of a program processor commences with receiving 902 an enrollment message from a user device by the program processor. The enrollment message corresponds to a particular prescription drug and includes an identifier of the user device. A lookup 904 is performed in an enrollment database of or communicatively connected to the program processor. If the lookup shows that the user device, via the identifier, is already enrolled in the program, the method 900 proceeds to a step of performing any of the methods 200, 300, 400, 500, 600, 700, 800 for the user device. If the lookup shows that the user device, via the identifier, is not already enrolled in the program, the method 900 proceeds to a step 906 of transmitting an enrollment message by the program processor to the user device. The enrollment message may include, for non-exclusive example, a request for additional information of the user device, a request for consent or authorization (e.g., a HIPAA consent or other), a welcome message, or other message(s). If the enrollment message requires a response from the user device and the user device responds accordingly, the program processor receives 908 the responsive message. The program processor then enrolls the user device in the program of the program processor by saving a user device record, together with a unique identifier of the user device, in the enrollment database. Prescription drug claim transaction data for the enrolled user device is then accessed by the program processor from the claims processor for performing any of the methods 200, 300, 400, 500, 600, 700, 800.

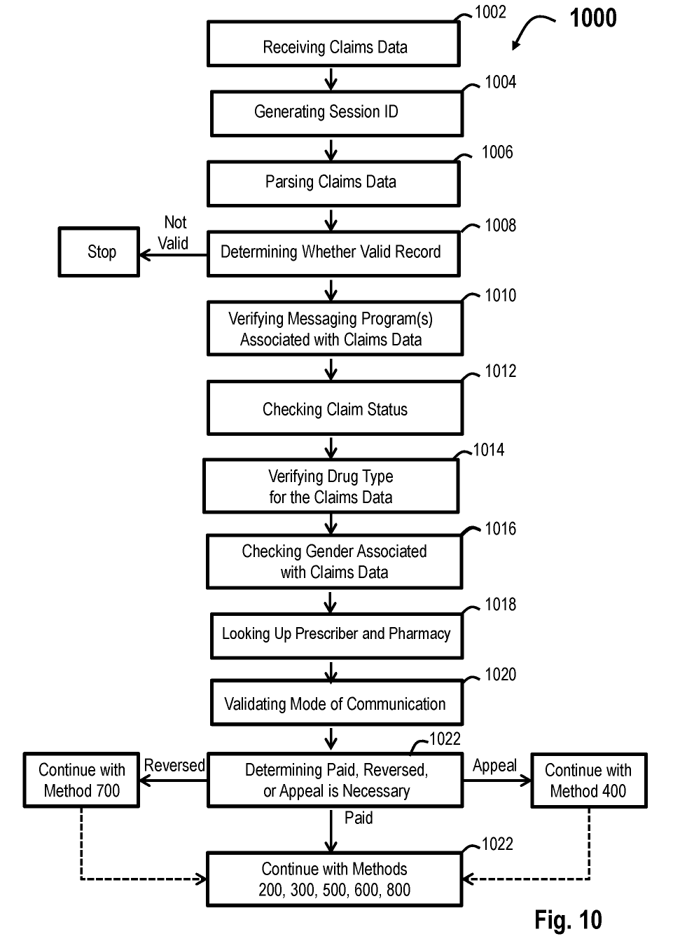

Referring to FIG. 10, a method 1000 of analyzing by a rules engine of a program processor in certain non-exclusive embodiments of the methods 200, 300, 400, 500, 600, 700, 800, includes receiving 1002 prescription drug claim transaction data from a source device, such as a benefits processor. For the received claim transaction data, the rules engine generates a session identifier 1004. The rules engine then parses 1006 the claim transaction data.

From the parse 1006, the rules engine determines 1008 whether the claim transaction data is a valid record. If not, the method 1000 ends. If the claim transaction data is a valid record, the rules engine verifies 1010 which messaging program of the methods 200, 300, 400, 500, 600, 700, 800 associated with the rules engine is associated with the claims transaction data. The rules engine then checks the claim status 1012 associated with the claim transaction data.

After checking 1012 the claim status, the rules engine verifies 1014 the drug type of the claim transaction data, which may include a lookup in an NDC database. The rules engine then checks the gender 1016 of the person associated with the claim transaction data. Based on a prescriber or pharmacy of the claim transaction data, the rules engine may perform a lookup 1018 of the prescriber or pharmacy in an NPI database. The rules engine then validates 1020 a mode of communication associated by the program processor with the user associated with the claim transaction data.

The rules engine logically determines 1022, based on the claim transaction data, whether the claim associated with the claim transaction data is paid, reversed or an appeal is necessary. If the claim was paid (i.e., the prescription drug of the claim transaction data was purchased and delivered), the method 1000 of analyzing by the rules engine stops and any of the methods 200, 300, 500, 600, 800, as applicable, continue. If the claim was reversed, the method 1000 of analyzing by the rules engine stops and the method 700 continues, which may be followed by, as applicable, any of the methods 200, 300, 500, 600, 800. If appeal is necessary for the claim, the method 1000 of analyzing by the rules engine stops and the method 400 continues, which may be followed by, as applicable, any of the method 200, 300, 500, 600, 800.

Various alternatives and additions are possible in the foregoing embodiments. In certain alternatives, the claims processor is a computer or computers operated by a health insurance provider, pharmacy benefits provider, government program, third party payer system, drug manufacturers, other vendors and/or business associates of healthcare service providers, government and/or non-government entities providing financial and/or administrative services, or other vehicle for adjudication of prescription drug claims. In other alternatives, the claim processor is another node of the communications network, such as a switch or other transceiver of the network, that receives and transmits claims data. The particular claims data that is received by the program processor may be widely varied. The rules engine accordingly is programmed for the variety of the claims data.

The program processor may, in certain alternatives, be operated by a discount or other award program provider. The discount or other award program may include communication of discount coupons or other awards. In other alternatives, the program processor may operate a health management program, alone or in conjunction with other program, such as a discount or award program. The health management program may itself include discount or award coupons and other advantages to program enrollees for adherence to health regimen or otherwise.

In other alternatives, the program processor and claims processor may be unitized or include a distributed computing environment. Applicable communications between pharmacy gateway, claims processor, program processor, and/or user device may be over same or disparate communications networks, which may be selected from wide variety of various channels or links, including wired and wireless links. For example, the communications between the pharmacy gateway and the claims processor, as well as between the claims processor and the program processor, may be by dedicated, secure network, or other secure channels. Communications between the program processor and the user device may be secured and include public or private networks, including, for example, wireless cellular or other wireless channels.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems and device(s), connection(s) and element(s) that may cause any benefit, advantage, or solution to occur or become more pronounced are not to be construed as a critical, required, or essential feature or element of any or all the claims. As used herein, the terms “comprises, “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system for messaging in a data communications network communicatively connected to a claims processor and a user device, comprising:
a processor;
a network interface communicatively connected to the processor and the data communications network;
a memory communicatively connected to the processor, the memory includes instructions for causing the processor to:
receive over the data communications network from the claims processor a set of prescription drug claims data associated with the user device;
analyze the prescription drug claims data; and
message the user device over the data communications network.

2. The system of claim 1, wherein the instructions cause the processor to:
determine an indicator of the prescription drug claims data, the indicator selected from the group consisting of: a date for refill of a prescription, an end of prescription date, a prior authorization requirement, a no insured coverage, an eligible award, a paid claim that is reversed, and a particular profile relevant to the user device and the prescription drug claims data.

3. The system of claim 2, wherein the instructions cause the processor to message the user device over the data communications network responsive to determining the indicator.

4. A method, comprising:
receiving by a server computer a prescription drug claim transaction data from a claims processor over a data communications network;
analyzing the prescription drug claim transaction data;
messaging a user device of a prescription drug customer in respect of the prescription drug claim transaction data.

5. The method of claim 4, wherein the analyzing detects an indicator of a redemption of a discount coupon associated with a prescription drug related to the user device and the prescription drug claim transaction data, further comprising:
storing the indicator in a redemption database communicatively connected to the server computer;
calculating by the server computer a reminder date for refill of the prescription drug;
storing by the server computer the reminder date in the redemption database;
querying by the server computer the redemption database to determine if the reminder date is reached;
if the reminder date is reached, messaging the user device with a refill reminder;
receiving by the server computer a message relative to the refill reminder from the user device as a refill request.

6. The method of claim 5, further comprising:
sending by the server computer the refill request to a pharmacy gateway associated with the user device.

7. The method of claim 4, wherein the analyzing determines an indicator of a redemption of a discount coupon associated with a prescription drug related to the user device and the prescription drug claim transaction data, further comprising:
storing the indicator in a redemption database communicatively connected to the server computer;
calculating by the server computer an end of prescription date for the prescription drug;
storing by the server computer the end of prescription date in the redemption database;
querying by the server computer the redemption database to determine if the end of prescription date is reached;
if the end of prescription date is reached, searching a database communicatively connected to the server computer for a contact information for a prescribing doctor and messaging by the server computer the user device with the contact information for the prescribing doctor for refill of the prescription drug.

8. The method of claim 7, wherein the database is accessed by the server computer over the data communications network and is selected from the group consisting of: a national provider identifier (NPI) database and a drug enforcement administration (DEA) database.

9. The method of claim 4, wherein the analyzing determines an indicator of a prior authorization requirement for fill of a prescription drug related to a user of the user device, further comprising:
storing the indicator in a database communicatively connected to the server computer;
messaging by the server computer the user device with a request for consent to pursue an appeal of the prior authorization requirement;
receiving by the server computer from the user device a written authorization and request to pursue the appeal.

10. The method of claim 4, wherein the analyzing determines an indicator selected from the group consisting of: no insured coverage, prior authorization requirement, and particular profile of the user device and the prescription drug claim transaction data, further comprising:
storing the indicator in a database communicatively connected to the server computer;
querying by the server computer the database to determine the indicator;
messaging by the server computer the user device with a request for consent to mail order service;
receiving by the server computer from the user device a consent to pursue mail order service.

11. The method of claim 4, further comprising:
searching by the server computer a rewards program device communicatively connected to the server computer, for an indicator of an available award associated with a user of the user device and the prescription drug claim transaction data;
receiving by the server computer from the rewards program device the indicator of the available award; and
messaging by the server computer the user device with the available award.

12. The method of claim 4, wherein the analyzing determines an indicator of a paid claim that is reversed, further comprising:
messaging by the server computer the user device with the message that the paid claim is reversed.

13. The method of claim 4, wherein the analyzing determines a particular profile of the user device and associated prescription drug claim transaction data, further comprising:
creating a survey corresponding to the user device and the associated prescription drug claim transaction data;
obtaining a unique URL for the survey and the user device;
populating the survey with information of the associated prescription drug claim transaction data;
messaging by the server computer the user device with a link to the URL of the survey;
receiving by the server computer from the user device a response to the survey;
looking up the response in a database communicatively connected to the server computer;
messaging by the server computer a physician device responsive to the response received from the user device.

14. The system of claim 1, wherein analyzing includes determining a refill date for refill of a prescription drug of the set of prescription drug claims data and calculating a date for a refill reminder;
wherein the message includes the refill reminder for refill of the prescription drug of the set of prescription drug claims data.

15. The system of claim 14, further comprising:
a pharmacy gateway communicatively connected to the processor, the pharmacy gateway is associated with the set of prescription drug claims data;
wherein the instructions further cause the processor to:
receive over the communications network from the user device a request for refill; and
contact the pharmacy gateway associated with the set of prescription drug claims data to request refill of the prescription drug associated with the set of prescription drug claims data.

16. The system of claim 1, further comprising:
a database of contact information for a prescribing doctor associated with the set of prescription drug claims data, the database is communicatively connected to the processor;
wherein the instructions further cause the processor to:
search the database communicatively connected to the server computer for a contact information for the prescribing doctor associated with the set of prescription drug claims data;
wherein the message includes the contact information for the prescribing doctor for refill of the prescription drug of the set of prescription drug claims data.

17. The system of claim 1, wherein analyzing determines an indicator of a prior authorization requirement for refill of a prescription drug related to the set of prescription drug claims data;
wherein the message includes a request for written authorization and request to pursue an appeal of the prior authorization requirement.

18. The system of claim 1, wherein analyzing determines an indicator selected from the group consisting of: no insured coverage, prior authorization requirement, and particular profile of the user device and the set of prescription drug claims data;
wherein the message includes a request for consent to mail order service for purchase and delivery of the prescription drug of the prescription drug claims data.

19. The system of claim 1, further comprising:
a rewards program device communicatively connected to the processor;
wherein the instructions further cause the processor to:
search the rewards program device for any available award associated with the set of prescription drug claims data,
receive by the processor from the rewards program device an indicator of an available award associated with the set of prescription drug claims data;
wherein the message includes the available award.

20. The system of claim 1, wherein analyzing determines an indicator of a paid claim that is reversed associated with the set of prescription drug claims data;
wherein the message includes that the paid claim is reversed.

21. The system of claim 1, wherein analyzing determines a particular profile of the user device and the set of prescription drug claims data;
wherein the instructions further cause the processor to:
create a survey corresponding to the user device and the set of prescription drug claims data;
obtain a unique URL for the survey and the user device;
populate the survey with information of the set of prescription drug claims data;
wherein the message includes a link to the URL of the survey.
